(19) United States
(12) Patent Application Publication
(10) Pub. No.: US 2022/0123571 A1
(43) Pub. Date: Apr. 21, 2022

(54) DEVICE FOR ADAPTING AN EXTERNAL CONTROL DEVICE TO A BATTERY-OPERATED POWER TOOL

(71) Applicant: Current Tools, Inc., Wellford, SC (US)

(72) Inventor: David Adam Spencer, Greer, SC (US)

(21) Appl. No.: 17/074,525

(22) Filed: Oct. 19, 2020

(51) Int. Cl. H02J 7/00; H01R 31/06; H01R 13/631; B25F 5/02

(52) U.S. Cl. CPC H02J 7/0063; H01R 31/06; H02J 7/0045; B25F 5/02; H01R 13/631

(57) ABSTRACT

An adapter device that comprises an adapter housing that includes a primary side for interfacing a battery unit and a secondary side for interfacing with a power tool device. The adapter device further includes an external control device that is coupled to the adapter housing via a wired connection, wherein activation of the external control device permits the adapter housing to control the supply of electrical power from the battery unit to the power tool device.

### TECHNICAL FIELD

The subject matter described herein relates to battery-operated power tools and associated adapters. More particularly, the subject matter described herein relates to a device for adapting an external control device to a battery-operated power tool.

### BACKGROUND

A battery-operated power tool typically constitutes a cordless hand-held device that is designed to draw electrical energy from a battery unit power source to power the device's motor. Actuation of a battery-operated power tool is usually conducted by depressing a power tool's integrated activation trigger via the operator's finger(s) or hand. Likewise, ceasing actuation of a battery-operated power tool is typically achieved by releasing the power tool's activation trigger. Notably, most handheld cordless power tool devices requires one or two hands to be properly operated by a user. As such, certain work applications that need an operator's manual attention (e.g., pulling cable in conduit) can prove to be problematic and difficult to accomplish when the work task also requires the simultaneous operation of the battery-operated power tool.

Accordingly, there exists a need for a device for adapting an external control device to a battery-operated power tool.

### SUMMARY

In some embodiments, the disclosed subject matter includes an adapter device that comprises an adapter housing that includes a primary side for interfacing a battery unit and a secondary side for interfacing with a power tool device. The adapter device further includes an external control device that is coupled to the adapter housing via a wired connection, wherein activation of the external control device permits the adapter housing to control the supply of electrical power from the battery unit to the power tool device.

According to another aspect of the subject matter described herein, an adapter device wherein the external control device includes a foot pedal switch. According to another aspect of the subject matter described herein, an adapter device wherein the adapter housing supplies the electrical power from the battery unit to the power tool when the external control device is activated.

According to another aspect of the subject matter described herein, an adapter device wherein the secondary side of the adapter housing includes rail elements for interfacing slot channels of the battery unit.

According to another aspect of the subject matter described herein, an adapter device wherein the secondary side of the adapter housing includes slot channels for interfacing rail elements of the battery unit.

According to another aspect of the subject matter described herein, an adapter device wherein the primary side of the adapter housing includes rail elements for interfacing slot channels positioned on a terminal end of the power tool device.

According to another aspect of the subject matter described herein, an adapter device wherein the primary side of the adapter housing includes rail elements for interfacing slot channels positioned on a terminal end of the power tool device.

According to another aspect of the subject matter described herein, an adapter device wherein the adapter housing includes internal electrical connections that connect electrode terminals of the battery unit to terminal connections of the power tool device.

According to another aspect of the subject matter described herein, an adapter device wherein the power tool device is associated with a first manufacturer tool platform and the battery unit is associated with a second manufacturer tool platform.

According to another aspect of the subject matter described herein, an adapter device wherein the adapter housing includes internal electrical connections that directly connects a negative electrode of the battery unit to a negative terminal contact of the power tool device.

According to another aspect of the subject matter described herein, an adapter device wherein the adapter housing includes internal electrical connections that directly connects a positive electrode of the battery unit to a positive terminal contact of the power tool device

According to another aspect of the subject matter described herein, an adapter device wherein the adapter housing includes internal electrical connections that connects a positive electrode of the battery unit to a first conductive wire connected to the external control device and connects a positive terminal contact of the power tool device to second conductive wire connected to the external control device, wherein the first conductive wire and the second conductive wire are electrically coupled by a switch mechanism that is engaged when the external control device is actuated.

According to another aspect of the subject matter described herein, an adapter device wherein an activation switch of the power tool device is configured to remain in an activated position.

According to another aspect of the subject matter described herein, an adapter device wherein the activation switch is retained in a depressed position via a restraining device.

### BRIEF DESCRIPTION OF THE DRAWINGS

The subject matter described herein will now be explained with reference to the accompanying drawings of which:

FIG. 1 illustrates an exemplary assembled battery-operated power tool equipped with an adapter device according to an embodiment of the subject matter described herein;

FIG. 2 illustrates an exemplary battery-operated power tool and adapter device prior to assembly according to an embodiment of the subject matter described herein;

FIG. 3 illustrates a primary side of an exemplary adapter device and associated external control device according to an embodiment of the subject matter described herein;

FIG. 4 illustrates a secondary side of an exemplary adapter device and associated external control device according to an embodiment of the subject matter described herein; and

FIG. 5 illustrates an exemplary wiring diagram of an assembled battery-operated power tool equipped with an adapter device according to an embodiment of the subject matter described herein.

### DETAILED DESCRIPTION

The subject matter described herein relates to an adapter device for coupling an external control device to a battery-operated power tool. In some embodiments, the disclosed subject matter relates to an adapter device that can be attached to a battery-operated power tool (e.g., a hand-held drill) such that a user is permitted to operate the tool using an external switch or control device. For example, the adapter device may be designed to be positioned in between a “bare” battery-operated power tool and its corresponding battery unit for the purpose of attaching the external control device (e.g., foot pedal switch) to the battery-operated power tool unit. The premise of this configuration is to allow the assembled battery-operated power tool to be actuated by an operator via the use of this external control device in certain use cases. For example, there are several different scenarios where utilizing the battery-operated power tool's activator switch (e.g., finger trigger) may not be ideal, such as pulling lengths of cable through conduit. Moreover, the disclosed adapter device can be configured to function with any brand of battery-operated power tool provided that the adapter device is configured to receive both the battery unit and power tool body, thereby establishing a connection.

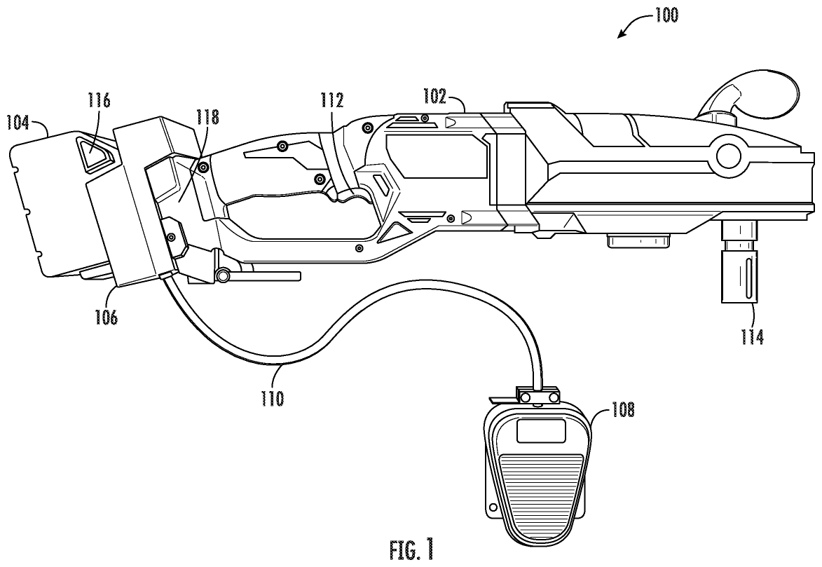

FIG. 1 illustrates an exemplary assembled battery-operated power tool equipped with an adapter device according to an embodiment of the subject matter described herein. As shown in FIG. 1, an assembled battery-operated power tool 100 is depicted as being equipped with an adapter device 106. In some embodiments, assembled battery-operated power tool 100 comprises a bare power tool 102 and an associated battery unit 104. Notably, battery unit 104 may comprise a rechargeable battery pack that includes a plurality of rechargeable battery cells. Battery unit 104 can be utilized to provide a power source to bare power tool 102 after installation and/or connection. In FIG. 1, bare power tool 102 includes an activation switch 112, such as a finger trigger or hand trigger. While bare power tool 102 is depicted in FIG. 1 as a cable pulling power tool, any battery-operated power tool configured to receive a battery unit as a power supply can utilize adapter device 106 without departing from the scope of the disclosed subject matter.

As shown in FIG. 1, adapter device 106 can be configured to be securely positioned in between bare power tool 102 and battery unit 104. Notably, adapter device 106 is designed to add an external control device 108 to assembled battery-operated power tool 100. In some embodiments, adapter device 106 is connected to external control device 108 by means of a wired connection 110. For example, wired connection 110 can include a sheathed electrical cord comprising internal conductive wiring (e.g., copper wires). The premise of the disclosed subject matter is to permit assembled battery-operated power tool 100 to be controllable and/or actuated by solely operating external control device 108 (i.e., not switching activation switch 112 on and off). As shown in FIG. 1, external control device 108 may be a foot pedal switch device that can be actuated by the operator's foot. Although FIGS. 1-4 depict external control device 108 as an foot pedal control switch, other implementations may be utilized without departing from the scope of the disclosed subject matter.

More specifically, FIG. 1 depicts an appropriately shaped version of adapter device 106 as being inserted between bare power tool 102 and battery unit 104. In particular, adapter device 106 is configured in such a manner that external control device 108 can be used to complete the electrical circuit connection of battery unit 104 to bare power tool 102 (described in greater detail below). In some embodiments, external control device 108 comprises a foot control switch. In some embodiments, an activation switch 112 is depressed or retained by means of some restraining device (e.g., activation switch 112 is constantly positioned or held in the “on” position) such that actuation of external control device 108 activates an internal switching mechanism that completes the electrical circuit connection existing between battery unit 104 and a bare power tool device 102, thereby providing power from battery unit 104 to power tool 102 via adapter device 106. Accordingly, configuration of external control device 108 in this manner permits a user to control the activation of assembled battery-operated power tool 100 by solely activating external control device 108 (e.g., stepping on foot pedal switch to turn on the power tool). In an alternative embodiment, adapter device 106 can be configured to deny the supply of electrical power from battery unit 104 to the power tool 102 upon the activation of the internal switching mechanism (described in additional detail below).

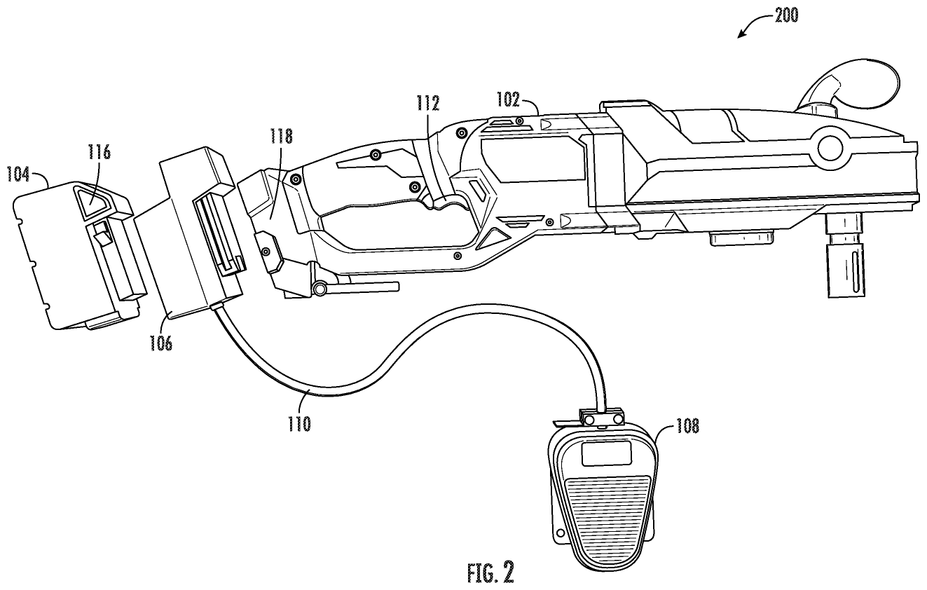

FIG. 2 depicts a disassembled battery-operated power tool 200 comprising a bare power tool 102, adapter device 106, and battery unit 104. Notably, disassembled battery-operated power tool 200 depicts all of the separate components and relative positions prior to the assembly of battery-operated power tool 100 shown in FIG. 1.

At present, most battery-operated power tools are configured in such a manner that the battery unit is easily removable from the bare power tool for charging and replacing. In many cases, battery-operated power tools are configured and/or equipped with an interlock mechanism that facilitates the ease of removal and interchangeability of the battery unit. For example, one implementation of this interlock mechanism includes a slide design where the battery unit is inserted into the bare power tool via a slot channel that is formed on the terminal end of the bare power tool. Notably, the battery unit can be configured with a notched or rail element that can be received by the slot channel (e.g., rail-like slide) of the bare power tool. Once the battery unit is interfaced and engaged with the bare power tool using the rail like slide (i.e., interlocking the rail element with the matching slot channel), the battery unit can be retained and secured to the bare power tool using a latch mechanism included on the battery unit (e.g., latch mechanism 116 in FIG. 1). In some embodiments, a latch mechanism is configured on the terminal end of the bare power tool. In alternate embodiments, the battery unit can be equipped with slot channel while the bare power tool is configured with the rail element.

In other embodiments, a cylindrical shaped battery unit can be inserted into a hollow cylindrical receiver tube located on the bare power tool (e.g., terminal end 118 or bottom end of the power tool). Once inserted and positioned securely in the hollow cylindrical receiver tube, the battery unit can be securely retained using a latch mechanism on either the battery unit or the terminal end 118 of the bare power tool.

Notably, the latching mechanisms described above can be used to engage and subsequently release the battery unit from the bare power tool via a mechanical push button that is attached to either the bare power tool or the battery unit itself. Regardless of the implementation, the interlock mechanism serves two functions. First, the interlock mechanism is configured to align the electrical contacts of the battery unit with the electrical contacts of the bare power tool. As such, this alignment of electrical contacts ensures a smooth and proper connection. The interlock mechanism also serves to retain this proper electrical connection between the battery unit and the bare tool device once attained. Similarly, the interlock mechanism secures the battery unit to the bare power tool to ensure proper retention of the battery unit during the normal use and operation of the battery-operated power tool. With regard to the subject matter disclosed herein, the described adapter device includes a primary side (e.g., a tool facing side) and a secondary side (e.g., a battery facing side) that are configured to utilize the interlock mechanism of the battery unit and the bare power tool. In particular, the adapter device disclosed herein is configured to leverage the existing interlocking mechanisms positioned in between the battery unit and the bare power tool.

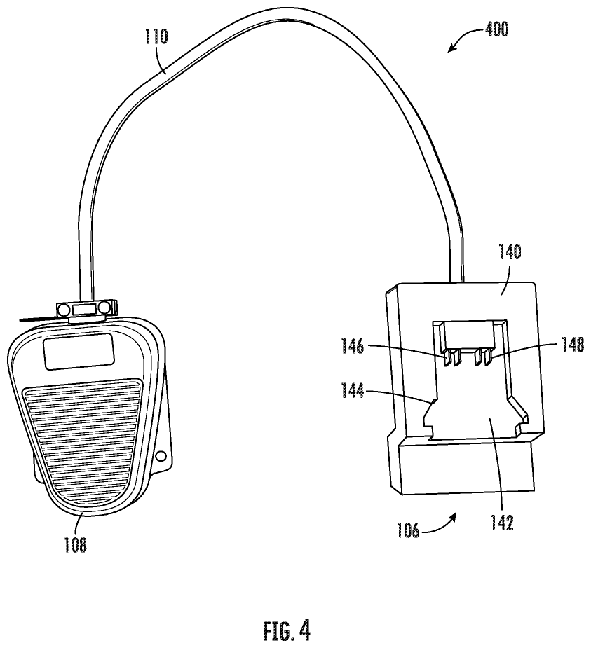

In some embodiments, bare power tool 102 usually connects to battery unit 104 via a slide and latch mechanism, wherein the latch release (e.g., latching mechanism 116) is implemented into the battery unit housing. Adapter device 106 is therefore appropriately formed and configured to receive battery unit 104 on the secondary side 140 (shown in FIG. 4) of the adapter housing. Accordingly, adapter device 106 is adapted to accept the latching mechanism 116 of battery unit 104, thereby locking battery unit 104 securely in place with respect to the adapter housing of adapter device 106. Furthermore, securing battery unit 104 to the adapter housing of adapter device 106 in this manner establishes and maintains the appropriate electrical connections existing between battery unit 104 and external control device 108, which is coupled to adapter device 106 via conductive wiring in wired connection 110.

In some embodiments, battery unit 104 of a battery-operated power tool needs a minimum of two electrical terminal contacts between bare power tool 102 and battery unit 104 (e.g., a positive terminal and negative terminal). Many functioning power tools will create an electrical connection between these two contacts of the battery unit and bare power tool and utilize a simple switch (e.g., a finger trigger on a power hand drill, such as activation switch 112 in FIG. 1) integrated into the bare power tool to control the electrical motor that powers the bare power tool.

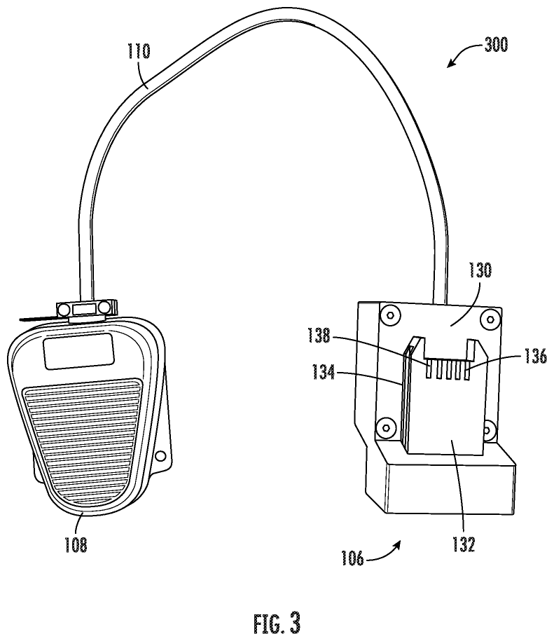

FIG. 3 illustrates a primary side of an exemplary adapter device and associated external control device according to an embodiment of the subject matter described herein. As shown in FIG. 3, adapter device 106 is depicted as including a primary side 130 that is configured to interface and/or establish a connection with a bare power tool 102. For example, primary side 130 may be formed and/or shaped such that adapter device 106 can accept or receive the terminal end 118 of bare power tool 102 such that electrical contact is established when adapter device 106 is interfaced and engaged with bare power tool 102.

Similarly, FIG. 4 illustrates a secondary side of an exemplary adapter device and associated external control device according to an embodiment of the subject matter described herein. More specifically, FIG. 4 illustrates a secondary side 140 of adapter device 106 that is shaped and formed such that secondary side 140 can accept battery unit 104 and establish electrical contact with battery unit 104. Notably, this connection establishes and facilitates the appropriate anode and cathode connections for battery unit 104 to interface with the appropriate terminal contacts of adapter device 106.

Returning to FIG. 3, adapter device 106 includes a primary side 130 that comprises a plurality of electrical contacts, including a negative terminal 138 and a positive terminal 136, which are configured to establish a physical connection with the terminal contacts of bare power tool 102. Further, negative terminal 138 of the primary side 130 of the adapter device 106 can be wired within the adapter housing of adapter device 106 directly to negative terminal 148 of the secondary side 140 (as shown in FIG. 4). Accordingly, the insertion and attachment of adapter device 106 in between the bare power tool 102 and the battery unit 104 results in a direct connection of the negative terminals. More specifically, the negative electrode of battery unit 104 can be directly connected to the negative terminal contact of bare power tool 102 via the negative terminals associated with an electrical connection (e.g., wired circuitry) established within the adapter housing of adapter device 106. In some alternate embodiments, the positive terminal of the primary side 130 of the adapter device 106 can be wired within the adapter housing of adapter device 106 directly to a positive terminal of the secondary side 140 (and the negative terminals are connected to the external control device 108 in the manner described below with regard to the positive terminals).

Likewise, the positive terminals associated with the primary side 130 and secondary side 140 of adapter device 106 can be electrically connected within the adapter housing in such a manner that external control device 108 (e.g., a foot operated switch) can be introduced and incorporated into the electrical circuit connection. Specifically, the electrical connection is configured in such a way that bare power tool 102 can be controlled by the external control device 108. For example, positive terminal 136 of the primary side 130 of adapter device 106 can be connected via wired connection 110 to a first terminal contact of external control device 108 (e.g., foot control switch) while the second terminal contact of external control device 108 is connected via wired connection 110 to positive terminal 146 on the secondary side 140 of adapter device 106. Consequently, the insertion of adapter device 106 in between bare power tool 102 and battery unit 104 results in external control device 108 being introduced and integrated into the electrical circuit of the entire assembled battery-operated power tool 100 via the positive terminals.

In particular, the positive electrode of battery unit 104 establishes contact with positive terminal 146 on the secondary side 140 to complete the aforementioned electrical circuit. In some embodiments, positive terminal 146 on the adapter housing is electronically connected to a first conductive wire (e.g., copper wiring) sheathed in connection 110, which runs to connection terminals of external control device 108. Likewise, a second conductive wire sheathed in connection 110 exits external control device 108 and connects to positive terminal 136 of adapter device 106, which can be used to establish contact directly to a positive terminal contact of bare power tool 102. As such, external control device 108 can be inserted into the assembled power tool's electrical circuit via the wiring included in connection 110 and the aforementioned positive terminals.

In some embodiments, an external restraining device, which may be configured to constantly depress the activation switch 112 (e.g., finger trigger) of the assembled battery-operated power tool 100, can be utilized in conjunction with the disclosed subject matter. Namely, by using a restraining device to constantly depress activation switch 112, actuation of external control device 108 (e.g., stepping on a foot pedal switch to close the electrical circuit of assembled battery-operated power tool 100) becomes the sole means by which activation and operation of assembled battery-operated power tool 100 is accomplished.

In some embodiments, more complex battery unit platforms can include more terminal contacts than the disclosed positive terminal and negative terminal. For example, these additional contact terminals can be included to facilitate additional functions pertaining to the operation and maintenance of the battery unit, such as charge monitoring, temperature monitoring, data transfer, and the like. In many cases, it is important for any adapter device to facilitate these additional functions in order for the battery-operated power tool to function properly. For example, the example battery unit 104 shown in FIG. 4 includes four (4) terminal contacts: a positive terminal, a negative terminal, a dedicated charging contact, and a terminal for monitoring battery health functions, such as temperature. In some embodiments, bare power tool 102 needs to be in constant communication with the battery health contact in order to ensure proper operation. In instances where constant communication cannot be maintained, assembled battery-operated power tool 100 will not permit electrical power to be drawn from battery unit 104.

In some embodiments of the disclosed subject matter, an external foot pedal switch (e.g., as an example of external control device 108), adapter device 106 can be configured in several different ways. For example, the charging contact may be omitted from adapter device 106 since this contact is not utilized during the operation of assembled battery-operated power tool 100. Moreover, similar to negative terminals 138 and 148 (as described above), the battery health contacts of adapter device 106 can be wired directly together from the primary side 130 of adapter device 106 to the secondary side 140 via electrical connections that are internal to the adapter housing.

Further, as indicated above, positive terminal 136 from the primary side 130 may be connected to a first end or terminal of external control device 108 via a first wire of connection 110. Similarly, the second end or terminal of external control device 108 can be connected to the positive terminal 146 of the secondary side 140 of the adapter device 106 via a second wire of connection 110. Therefore, insertion of the adapter device 106 between bare power tool 102 and battery unit 104 results in a direct connection of the negative terminals and the battery health contacts (e.g., via internal connections in the adapter housing), while the wiring of the external foot pedal switch is inserted into the electrical circuit of the assembled battery-operated power tool 100 via positive terminals 136 and 146 and wired connection 110. With the aid of an external restraining device that is configured to depress the power tool's integrated actuation switch (e.g., activation switch 112), assembled battery-operated power tool 100 can be actuated by a foot pedal switch (e.g., external control device 108).

While the examples provided herein demonstrate the manner in which the disclosed adapter device 106 may allow an assembled battery-operated power tool 100 to be controlled by a remote means (i.e., not utilizing the power tool's activation finger trigger to turn the power tool on and off), the described applications are not limited solely to remote actuation. Further possible applications of adapter device 106 may include the incorporation of external sensors to the battery-operated power tool for purposes of monitoring and controlling the supply of electrical power to the power tool (or prevent power being supplied to the power tool) when certain conditions are met (or failed to be met). Namely, the adapter can be adapted to control the supply of electrical power by either being configured to providing power or denying/ceasing power to the power tool upon activation.

In some instances, one possible application may include an external accelerometer that can be utilized to kill or stop the electrical power supplied by battery unit 104 if adapter device 106 experiences a sudden change in orientation (e.g. a “kick”). Likewise, adapter device 106 can be configured with an external timer mechanism to establish and control the duration of certain processes. The external timer mechanism can also be used to predefine a time period that may limit an operator to exposure of harmful vibrations that are generated by the use of the battery-operated power tool. In some embodiments, adapter device 106 can be further configured to include the incorporation of an operator-presence control mechanism that ensures the assembled battery-operated power tool 100 is not unintentionally actuated.

The battery-operated power tool market has seen a significant increase in popularity in recent years, with many power tool manufacturers striving for market share. In an attempt to accomplish this goal, these power tool companies have designed their power tools around a common battery “platform”. Namely, a manufacturer's battery platform affords each of the manufacturer's bare power tools on the platform the ability to freely interchange batteries with other bare power tools designed on the same platform. These platforms are often designed such that the manufacturer's power tools and batteries are not easily interchangeable with the power tools and batteries adhering to the competing manufacturers' platforms. This is often accomplished by designing and configuring the interlock mechanism to simply not fit or be compatible with a competitor's interlock mechanism, battery unit, and/or the bare power tool's terminal end.

In some embodiments of the disclosed subject matter, the adapter device is configured to allow an operator user to control a battery-operated power tool by means of an external control device and an equivalent battery from a platform that is different from a platform of the bare power tool. Similar to the example given above, a first side (e.g., primary side) of the adapter device can be appropriately adapted to be accepted by the power tool of a first power tool platform. Likewise, the second side (e.g., secondary side) of the adapter device is then appropriately configured to receive a battery unit of a different platform (e.g., a second power tool platform), with the appropriate electrical connection for the battery unit and external control device. Upon being received by the terminal end of the power tool, the adapter device is configured to establish the appropriate electrical connections for the bare power tool to interface with the external control device and the battery unit of the different/second power tool platform.

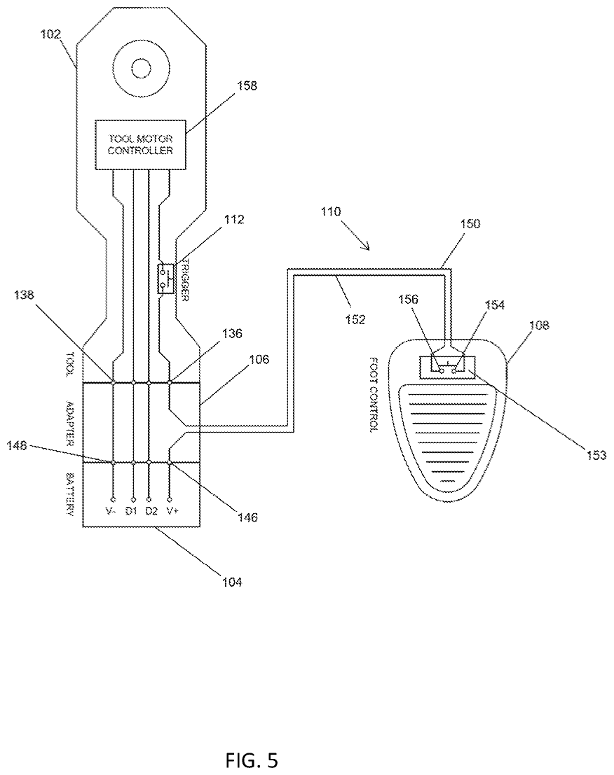

FIG. 5 illustrates an exemplary wiring diagram of an assembled battery-operated power tool equipped with an adapter device according to an embodiment of the subject matter described herein. As indicated in FIG. 5, a positive terminal 136 of adapter device 106 may be connected to a first end or first terminal 154 of external control device 108 via a first wire 150 of connection 110. Similarly, the second end or second terminal 156 of external control device 108 can be connected to the positive terminal 146 of the adapter device 106 via a second wire 152 of connection 110. Therefore, insertion of the adapter device 106 between bare power tool 102 and battery unit 104 results in a direct connection of the negative terminals (i.e., terminals 138 and 148 as shown in FIG. 5) and the battery health contacts (e.g., contacts shown as D1 and D2 in FIG. 5) via internal connections in the adapter housing. Further, the wiring of the external control device 108 is inserted into the electrical circuit of the assembled battery-operated power tool 100 via positive terminals 136 and 146 and wired connection 110.

With the aid of an external restraining device that is configured to depress the power tool's integrated actuation switch (e.g., trigger or activation switch 112) and thereby electrically close switch 112, assembled battery-operated power tool 100 can be actuated by a foot pedal switch (e.g., external control device 108). Notably, external control device 108 can be configured to open (or close) electrical switch 153 upon being depressed, thereby controlling the supply of electrical power from battery unit 104 to a tool motor controller 158 in power tool 102. For example, external control device 108 can be configured in such a manner that the act of depressing (e.g., stepping on) external control device 108 can electrically close switch 153, thereby completing the electrical circuit that is collectively enabled by the assembly of power tool 102, adapter device 106, and battery unit 104. Such a configuration would provide or enable the supply of electrical power to power tool 102 when the external control device 108 is depressed. Alternatively, external control device 108 can be configured in such a manner that the act of depressing (e.g., stepping on) external control device 108 can electrically open switch 153, thereby opening or “breaking” the electrical circuit that is collectively enabled by the assembly of power tool 102, adapter device 106, and battery unit 104. Such a configuration would deny the supply of electrical power to power tool 102 when the external control device 108 is depressed.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. An adapter device comprising:
an adapter housing that includes a primary side for interfacing a battery unit and a secondary side for interfacing with a power tool device; and
an external control device that is coupled to the adapter housing via a wired connection, wherein activation of the external control device permits the adapter housing to control the supply of electrical power from the battery unit to the power tool device.

2. The adapter device of claim 1 wherein the external control device includes a foot pedal switch, an emergency stop button, an operator-presence control mechanism, or an anti-tie down switch.

3. The adapter device of claim 2 wherein the adapter housing supplies the electrical power from the battery unit to the power tool device when the external control device is activated.

4. The adapter device of claim 1 wherein the secondary side of the adapter housing includes rail elements for interfacing slot channels of the battery unit.

5. The adapter device of claim 1 wherein the secondary side of the adapter housing includes slot channels for interfacing rail elements of the battery unit.

6. The adapter device of claim 1 wherein the primary side of the adapter housing includes rail elements for interfacing slot channels positioned on a terminal end of the power tool device.

7. The adapter device of claim 1 wherein the primary side of the adapter housing includes rail elements for interfacing slot channels positioned on a terminal end of the power tool device.

8. The adapter device of claim 1 wherein the adapter housing includes internal electrical connections that connect electrode terminals of the battery unit to terminal connections of the power tool device.

9. The adapter device of claim 1 wherein the power tool device is associated with a first manufacturer tool platform and the battery unit is associated with a second manufacturer tool platform.

10. The adapter device of claim 1 wherein the adapter housing includes internal electrical connections that directly connects a negative electrode of the battery unit to a negative terminal contact of the power tool device.

11. The adapter device of claim 1 wherein the adapter housing includes internal electrical connections that directly connects a positive electrode of the battery unit to a positive terminal contact of the power tool device.

12. The adapter device of claim 1 wherein the adapter housing includes internal electrical connections that connects a positive electrode of the battery unit to a first conductive wire connected to the external control device and connects a positive terminal contact of the power tool device to second conductive wire connected to the external control device, wherein the first conductive wire and the second conductive wire are electrically coupled by a switch mechanism that is engaged when the external control device is actuated.

13. The adapter device of claim 1 wherein an activation switch of the power tool device is configured to remain in an activated position.

14. The adapter device of claim 13 wherein the activation switch is retained in a depressed position via a restraining device.
